(19) United States
(12) Patent Application Publication
(10) Pub. No.: US 2006/0279543 A1
(43) Pub. Date: Dec. 14, 2006

(54) Method and device for preventing unintended input of information in an electronic device

(75) Inventor: Sanna Koskinen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/150,862

(22) Filed: Jun. 9, 2005

(51) Int. Cl. G09G 5/08

(52) U.S. Cl. 345/161

(57) ABSTRACT

In an electronic device having a multi-dimensional input device to input information, a mechanical restraining mechanism is used to mechanically engage with at least a part of the multi-dimensional device when the latter is not used so as to prevent unintended input of information in the electronic device. The multi-dimensional input device can be a joystick or a sliding disc, which can be latched to a docking slot or engaged with a clamp.

### FIELD OF THE INVENTION

The present invention relates to an information inputting means disposed on an exterior surface of an electronic device for inputting information in the electronic device and, more particularly, to a method and a mechanism for preventing unintended input of information in the electronic device.

### BACKGROUND OF THE INVENTION

In an electronic device, such as a mobile phone, a PDA and a communicator device, keys and buttons are usually used to allow a user to input information either by creating a signal or disrupting a signal in the electronic device. If the keys or buttons are located on an exposed surface, they could be pressed unintentionally when the electronic device is placed in a pocket or a purse, for example. This can be annoying. One way to prevent unintended pressing is to turn off the electronic device or to disable some of the keys using a keypad lock function. However, many mobile phone users prefer keeping the phone turned on so that they will not miss incoming calls. Furthermore, a keypad locking function, in general, is found not to be intuitive.

A foldable mobile phone usually has a main body linked to a cover. The cover has an inner surface facing the main body when the mobile phone is folded. The cover also has an outside surface opposing the inner surface. A foldable mobile phone has an interior display disposed on the inner surface of the cover. Some foldable mobile phones have an exterior display located on the outside surface of the cover. The exterior display is usually used to display the time of the day or a short text message related to an incoming call. The exterior display can also be used to display a longer text message if there are some keys or buttons located on the outside surface of the cover so as to allow the user to move and shift the displayed text. Preferably, the user is not required to disable these “exposed” keys or buttons when they are not used to input information in the mobile phone.

It would be advantageous to provide a method and a device for preventing unintended input of information in the mobile phone if these “exposed” input devices are located on an exterior surface of the mobile phone.

### SUMMARY OF THE INVENTION

The present invention uses a multi-directional input device such as a joystick disposed on the exterior surface for inputting information in an electronic device. By moving the multi-directional input device in one or more directions relative to the exterior surface, the user provides electronic signals to the electronic components in the electronic device. In order to prevent unintended moving of the multi-directional input device, the present invention provides a mechanical restraining mechanism such that the multi-directional input device can be effectively locked when it is engaged with the restraining mechanism.

On a foldable mobile phone, for example, a joystick can be disposed on the outside surface of the phone cover to allow a user to move the joystick in order to input information in the mobile phone. A docking slot on the cover adjacent to the joystick is used to latch the joystick in place, rendering the joystick immobile. Thus, when the joystick is not used, it can be moved into the docking position so as to prevent unintended moving of the joystick.

In another embodiment, a clamp having a restraining slot is disposed adjacent to the joystick. When the joystick is not used, the clamp can be slid toward the joystick to immobilize the joystick. Furthermore, the joystick can be relocated between a first position and a section position. In the first position, the joystick can be moved in different directions. In the second position, the joystick is engaged with a mechanical restraining mechanism, rendering the joystick substantially immobile.

The multi-directional input device can also have a contact plate and a sliding disc slidably mounted on the contact plate. The sliding disc can be caused to mechanically engage with a mechanical restraining mechanism.

The present invention will become apparent upon reading the description taken in conjunction with FIGS. 1 to 11b.

### BRIEF DESCRIPTION OF THE DRAWINGS

FIG. 1a is a schematic representation showing a side view of a foldable phone having a display screen and a joystick on the cover, wherein the joystick is in an unlocked position.

FIG. 1b is a schematic representation showing the side view of the foldable phone wherein the joystick is in a locked position.

FIG. 2a is a schematic representation showing a plan view of the foldable phone, wherein the joystick is in the unlocked position.

FIG. 2b is a schematic representation showing the plan view of the foldable phone wherein the joystick is in the locked position.

FIG. 3a is a schematic representation showing a side view of a joystick assembly wherein the joystick is in an unlocked position.

FIG. 3b is a schematic representation showing a side view of the joystick assembly wherein the joystick is in the locked position.

FIG. 4a is a schematic representation showing a top view of the joystick assembly wherein the joystick is in the unlocked position.

FIG. 4b is a schematic representation showing a top view of the joystick assembly wherein the joystick is in the locked position.

FIG. 5a is a schematic representation showing a side view of a foldable phone having a display screen and a joystick on the cover, wherein the joystick is disengaged from a restraining clamp.

FIG. 5b is a schematic representation showing the side view of the foldable phone wherein the joystick is engaged with the clamp.

FIG. 6a is a schematic representation showing a plan view of the foldable phone, wherein the joystick is disengaged from the clamp.

FIG. 6b is a schematic representation showing the plan view of the foldable phone wherein the joystick is engaged with the clamp.

FIG. 7a is a schematic representation showing a side view of the joystick assembly wherein the joystick is in a disengaged position.

FIG. 7b is a schematic representation showing a side view of the joystick assembly wherein the joystick is in the engaged position.

FIG. 8a is a schematic representation showing a top view of the joystick assembly wherein the joystick is in the disengaged position.

FIG. 8b is a schematic representation showing a top view of the joystick assembly wherein the joystick is in the engaged position.

FIG. 9a is a schematic representation of another joystick assembly, according to the present invention, wherein the joystick is in a disengaged position.

FIG. 9b is a schematic representation of joystick assembly of FIG. 9a, wherein the joystick is in an engaged position.

FIG. 10a is a schematic representation of another multi-directional input device, according to the present invention, wherein the device is in a disengaged position.

FIG. 10b is a schematic representation of the multi-directional input device of FIG. 10a, wherein the device is in an engaged position.

FIG. 11a is a schematic representation of yet another multi-directional input device, according to the present invention, wherein the device is in a disengaged position.

FIG. 11b is a schematic representation of the multi-directional input device of FIG. 11a, wherein the device is in an engaged position.

### DETAILED DESCRIPTION OF THE INVENTION

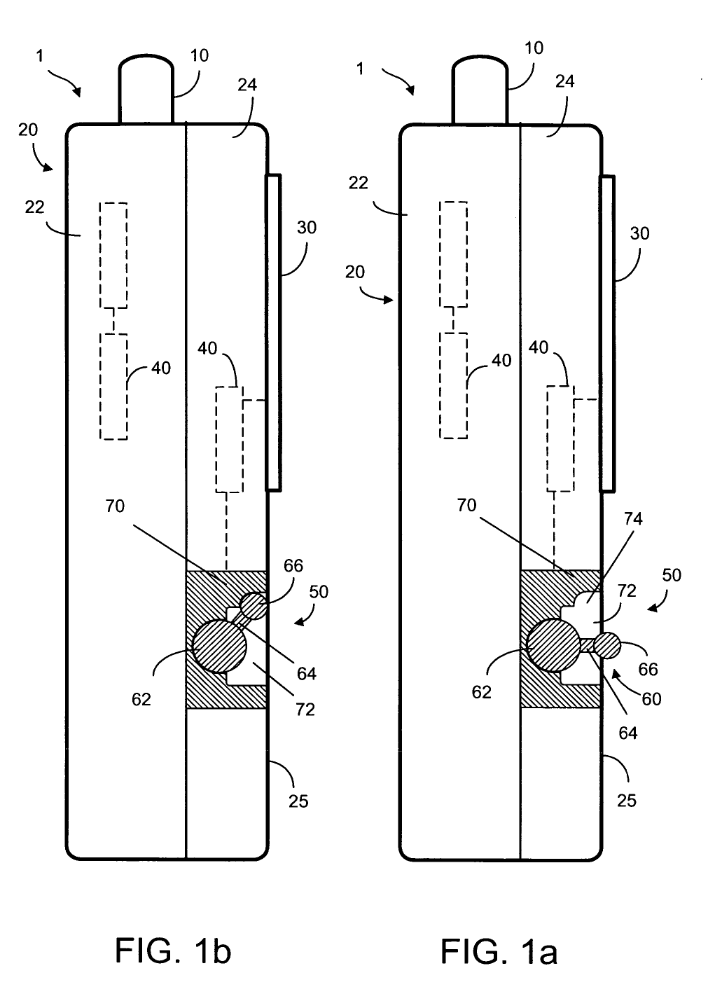

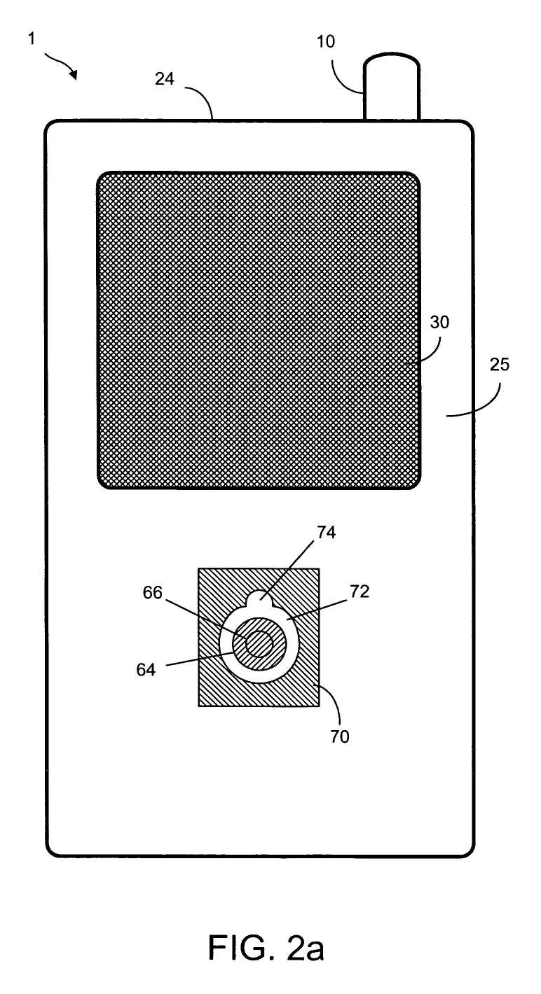

FIGS. 1a to 2b are schematic representations showing a side view and a plan view of a foldable mobile phone. As shown in FIGS. 1a to 2b, the mobile phone 1 has a housing 20 to house various electronic components 40 and antenna 10. The housing 20 has a main body 22 linked to a cover 24. The cover 24 has an exterior surface 25 and a display 30 disposed on the exterior surface 25. The mobile phone 1 also has a joystick assembly 50 for inputting information in the mobile phone 1. The joystick assembly 50 has ajoystick 60 and a retaining block 70 to retain the joystick. As shown in FIGS. 1a to 2b, the joystick 60 has a ball 62, a head 66 connected to the ball 62 by a stem 64. The retaining block 70 has a well 72 to allow the joystick to move in different directions in the well. The retaining block 70 further has a docking slot 74 for latching the joystick head 66.

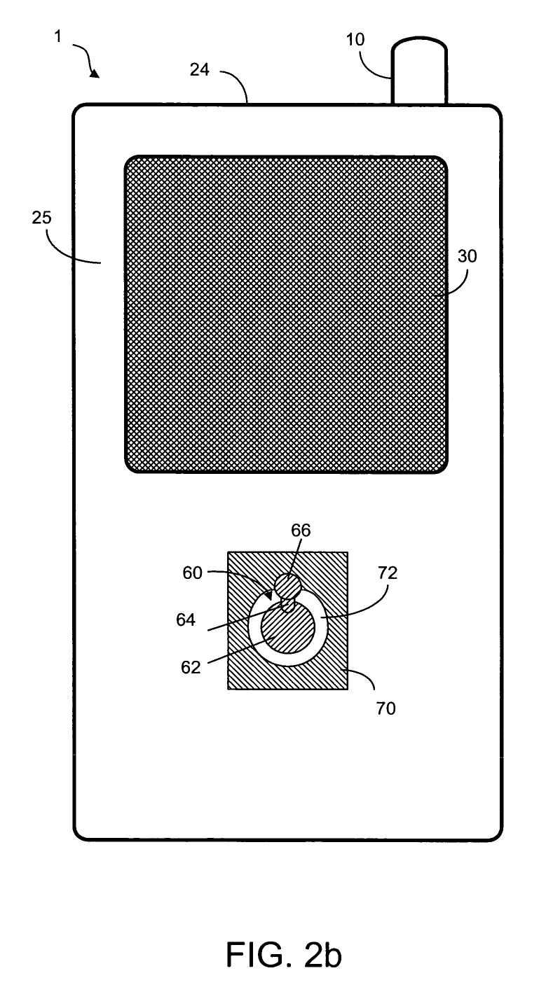

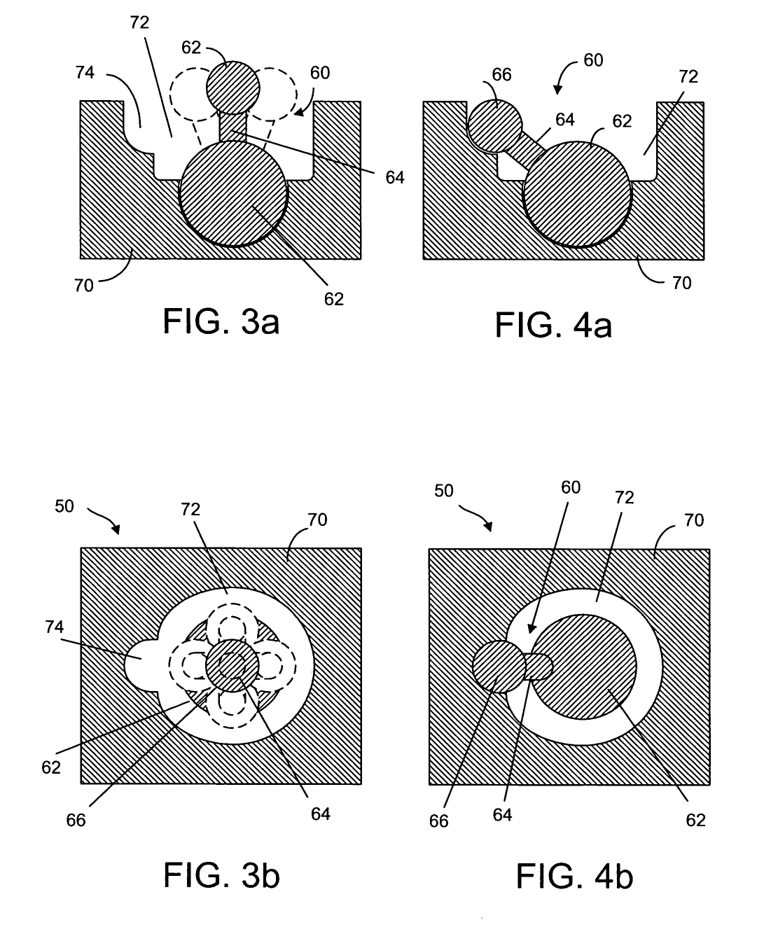

FIGS. 1a and 2a show the mobile phone 1 when the joystick 60 is in a normal operational position. FIG. 1b and 2b show the mobile phone 1 when the joystick 60 is in its docking position. FIGS. 3a to 3b show a side view and a top view of the joystick assembly 50 when the joystick is in its normal operational position. In this position, the user can push the joystick head 66 in different directions. FIG. 4a and 4b show a side view and a top view of the joystick assembly when joystick is in its docking position. In this position, the joystick head 66 is latched in the docking slot 74, rendering the joystick head 66 substantially immobile. As such, unintended moving of the joystick can be prevented even though the joystick is located on an outside surface of the mobile phone.

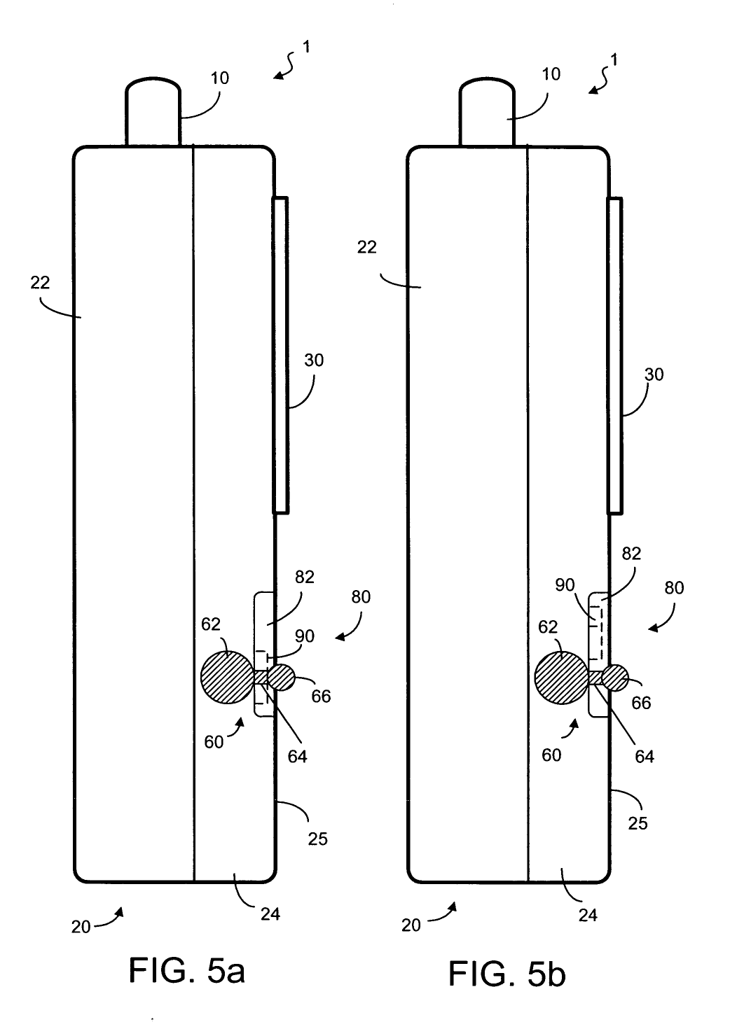

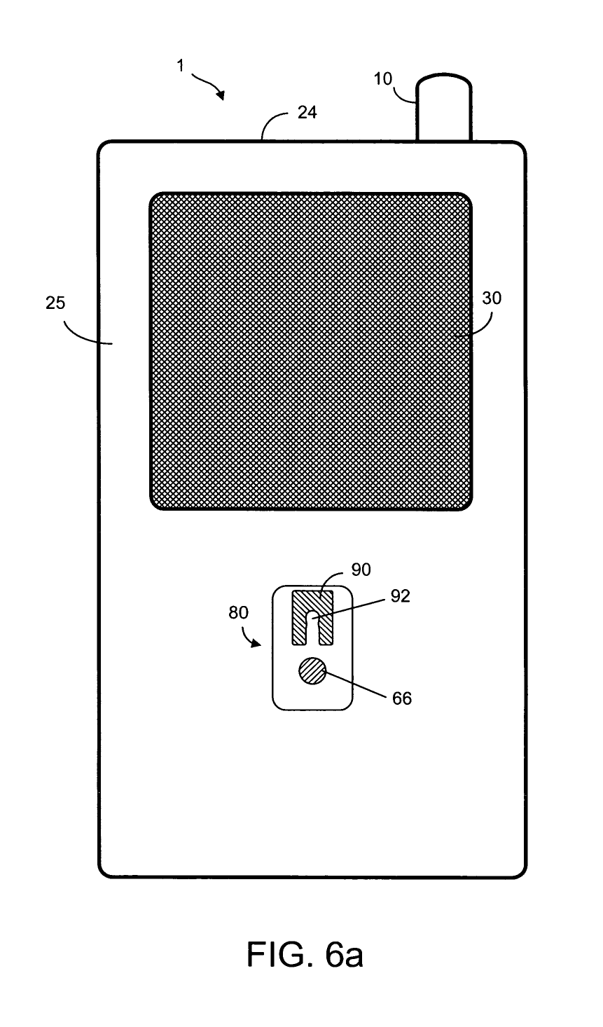

FIGS. 5a to 11b show another embodiment of the present invention. FIGS. 5a to 6b are schematic representations showing a side view and a plan view of a foldable mobile phone having ajoystick assembly 50. As shown in FIGS. 5a to 6b, the joystick assembly 50 has a joystick 60 and a retaining body 80 to retain the joystick. The retaining body 80 has a well 82 to allow the joystick to move in different directions in the well. The retaining body has a clamp 90 with a restraining slot 92 to be engaged with the joystick stem 64. The clamp 90 can be slid from one position to another.

FIGS. 5a and 6a show the mobile phone 1 when the joystick 60 is in a normal operational position and the clamp is remote from the joystick. FIG. 5b and 6b show the mobile phone 1 when the clamp 90 is moved toward the joystick 60 so that the restraining slot 92 of clamp 90 is engaged with the joystick stem 64, rendering the joystick 60 immobile.

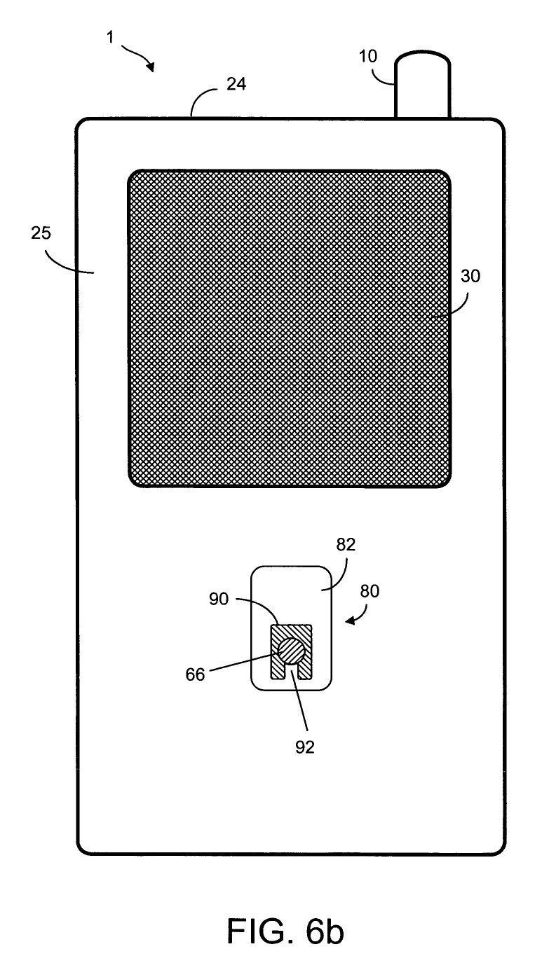

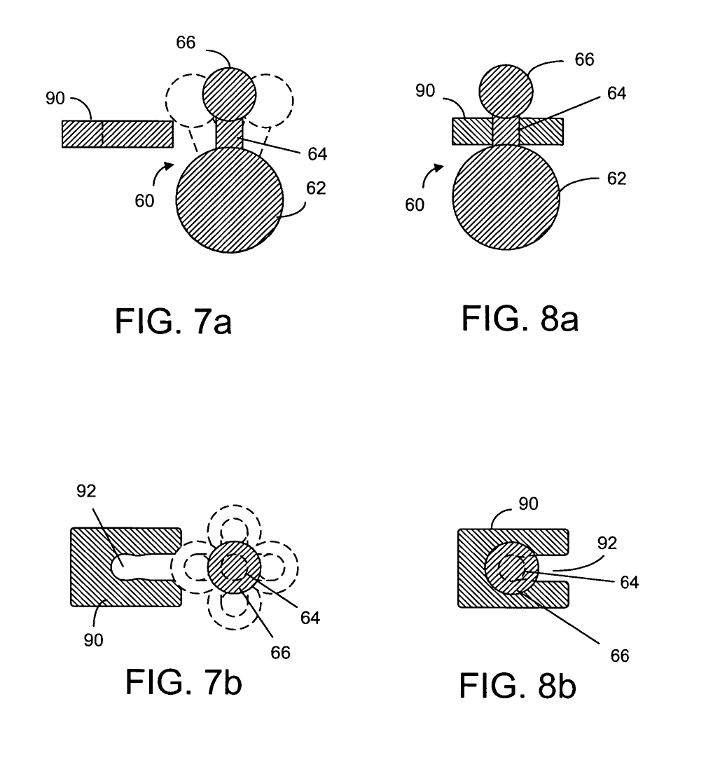

FIGS. 7a to 7b show the relative position of the restraining clamp 90 and the joystick 60 when the joystick is in its normal operational position. In this position, the user can push the joystick head 66 in different directions. FIG. 8a and 8b show the relative of position of the restraining clamp 90 and the joystick 60 when the joystick is in the engaged position. In this position, the joystick stem 64 is restrained by the slot 92. As such, unintended moving of the joystick can be prevented even though the joystick is located on an outside surface of the mobile phone.

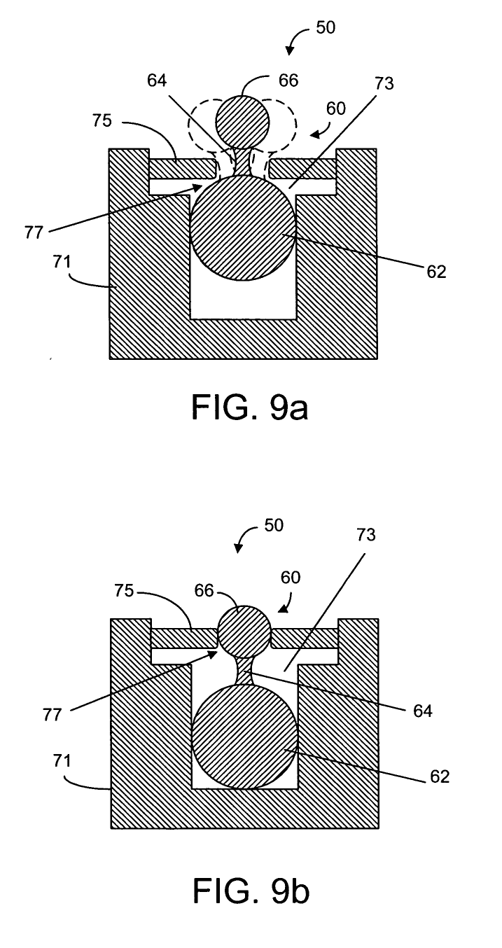

In another embodiment of the present invention, the retaining block 71 has a deep well 73 to retain the joystick 60 and a restraining ring 75 having an opening 77. When the joystick 60 is operated in its normal operational position, it is caused to stay in the upper portion of the well 73, as shown in FIG. 9a. Because the opening 77 in the restraining ring 75 is sufficiency wide as compared to the stem 64 of the joystick 60, the joystick can be moved around in different directions. When the joystick is not used, it can be pushed downward so that the head 66 is engaged with the restraining ring 75, rendering the joystick 60 immobile, as shown in FIG. 9b.

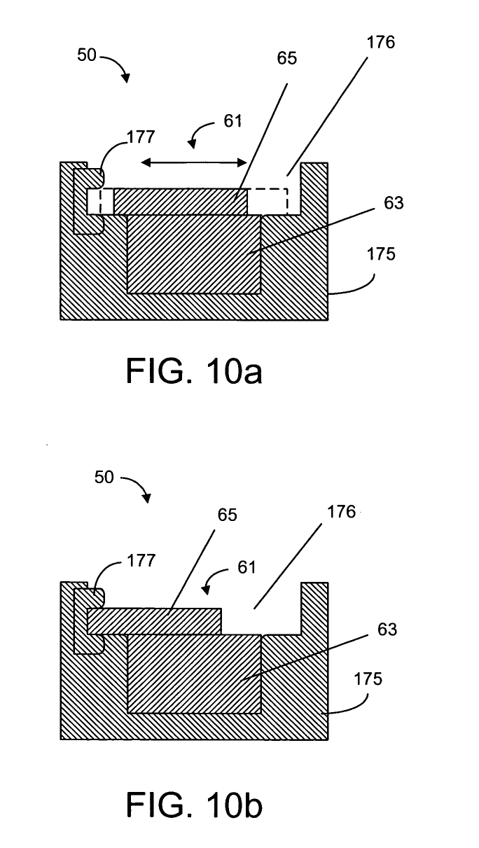

In yet another embodiment of the present invention, the joystick or multi-directional input device 61 comprises a contact plate 63 and a sliding disc 65 disposed on top of the contact plate 63. The retaining block 175 has a well 176 and the lower portion of the well 176 is used to retain the contact plate 63. The retaining block 175 further comprises a clamp 177-located on one side of the upper portion of the well 176. When the joystick 61 is in its normal operational position, the sliding disc 65 is disengaged from the clamp 177. In this position, the sliding disc 65 can be slid in different directions, as shown FIG. 10a. When the sliding disc is slid into the clamp 177, it is restrained from moving, as shown in FIG. 10b.

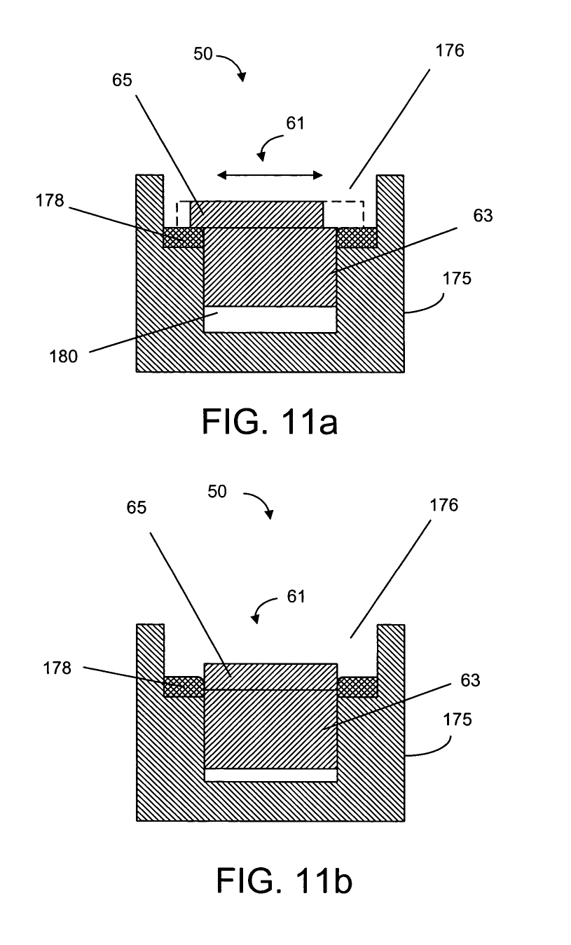

In a different embodiment, the depth of the lower portion 180 of the well 176 is greater than the height of the contact plate 63 and a ring 178 is disposed on top of the lower portion 180. When the joystick 61 is operated in its normal operational position, it is caused to stay upward so that the sliding disc is positioned above the ring 178, as shown in FIG. 11a. In this position, the sliding disc 65 can be slid in different directions. When the joystick is not used, it can be pushed downward so that the sliding disc 65 is also engaged with the ring 178, rendering the sliding disc 65 immobile, as shown in FIG. 11b.

In sum, the present invention uses a mechanical means to restrain a multi-directional inputting device in an electronic device. When the multi-directional inputting device is not used, it can be engaged with a latching mechanism so as to render the inputting device immobile. As such, unintended moving of the multi-directional inputting device can be prevented. In particular, the multi-directional inputting device is a joystick and the mechanical restraining means is a docking slot in a well or a restraining slot of a clamp. It should be appreciated that the joystick as shown in FIGS. 1a to 11b is disposed on an exterior surface of a foldable mobile phone. However, the same joystick assembly can be disposed on a surface of a non-foldable phone. On such a non-foldable electronic device, when the joystick is in the locked or engaged position, it can be also be used to disable other keys or buttons as well. It should be appreciated by persons skilled in the art that the various embodiments shown in FIGS. 1-11b are for illustration purposes only. For example, the electronic device 1 can be a mobile phone, but it can also be a communicator device, a PDA or the like. Furthermore, the antenna 10 in the electronic device 1 can be disposed within the housing 20 or replaced by an internal antenna of a different form.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for preventing input of information in an electronic device through a multi-directional input device, the electronic device having a housing, said method comprising:
disposing the multi-directional input device on the housing so as to input information by moving at least a part of the multi-directional input device;
disposing a mechanical restraining mechanism on the housing in a changeable spatial relationship with said part of the multi-directional input device; and
changing said spatial relationship so as to engage said part of the multi-dimensional input device with the restraining mechanism for preventing the multi-dimensional input device from inputting information in the electronic device.

2. The method of claim 1, wherein the multi-directional input device comprises a joystick having a spherical body and a steering member connected to the spherical body, and the housing comprises a retaining means to retain the spherical body for movement and a well to allow the steering member to move in different directions, and wherein the mechanical restraining mechanism comprises a docking slot located in relationship to the well so as to render the joystick substantially immobile when the steering member of the joystick is latched in the docking slot.

3. The method of claim 1, wherein the multi-directional input device comprises a joystick having a spherical body and a steering member connected to the spherical body, and the housing comprises a retaining means to retain the spherical body for movement and a well to allow the steering member to move in different directions, and wherein the mechanical restraining mechanism comprises a clamp located in relationship to the well, the clamp movable between a first position and a second position, the clamp having a slot, such that when the clamp is located in the first position, it allows the joystick to move in different directions, and when the clamp is located in the second position, the slot is engaged with the steering member of the joystick, rendering the joystick substantially immobile.

4. The method of claim 1, wherein the multi-directional input device comprises a joystick having a spherical body and a steering member connected to the spherical body, and the housing comprises a retaining means to retain the spherical body for movement and a well to allow the steering member to move in different directions, and wherein the mechanical restraining mechanism comprises a ring in relationship to the well, the ring having an opening, the joystick is movable between a first position and a second position, such that when the clamp is located in the first position, the steering member is allowed to move in different directions in the opening, and when the joystick is located in the second position, the steering member is engaged with the ring, rendering the joystick substantially immobile.

5. The method of claim 1, wherein the multi-directional input device comprises a contact plate and a sliding disc movably connected to the contact plate, and the housing comprises a retaining means to retain the contact plate and a well to allow the sliding disc to move in different directions relative to the contact plate, and wherein the mechanical restraining mechanism comprises a clamp disposed relative to the well so as to allow the sliding disc to engage with the clamp, rendering the sliding disc substantially immobile.

6. The method of claim 1, wherein the multi-directional input device comprises a contact plate and a sliding disc movably connected to the contact plate, the multi-dimensional input device movable between a first position and a second position, and the housing comprises a retaining block having an opening to retain the contact plate and a well to allow the sliding disc to move in different directions relative to the contact plate when the multi-directional input device is located in the first position, and wherein the mechanical restraining mechanism comprises a ring disposed in the upper part of the opening of the retaining block such that when the multi-directional input device is located in the second position, the sliding disc is engaged with the ring, rendering the sliding disc substantially immobile.

7. An electronic device comprising:
a housing;
a multi-directional input device disposed on the housing for inputting information in the electronic device;
a retaining body to retain the input device; and
a mechanical restraining mechanism disposed on the housing in a spatial relationship with at least a part of the multi-directional input device, such that the spatial relationship can be changed so as to mechanically engage said part of the multi-dimensional input device to the mechanical restraining mechanism for preventing the input device from inputting information in the electronic device.

8. The electronic device of claim 7, wherein the multi-directional input device comprises a joystick having a spherical body and a steering member connected to the spherical body, and the housing comprises a retaining means to retain the spherical body for movement and a well to allow the steering member to move in different directions, and wherein the mechanical restraining mechanism comprises a docking slot located in relationship to the well so as to render the joystick substantially immobile when the steering member of the joystick is latched in the docking slot.

9. The electronic device of claim 8, wherein the multi-directional input device comprises a joystick having a spherical body and a steering member connected to the spherical body, and the housing comprises a retaining means to retain the spherical body for movement and a well to allow the steering member to move in different directions, and wherein the mechanical restraining mechanism comprises a clamp located in relationship to the well, the clamp movable between a first position and a second position, the clamp having a slot, such that when the clamp is located in the first position, it allows the joystick to move in different directions, and when the clamp is located in the second position, the slot is engaged with the steering member of the joystick, rendering the joystick substantially immobile.

10. The electronic device of claim 7, wherein the multi-directional input device comprises a joystick having a spherical body and a steering member connected to the spherical body, and the housing comprises a retaining means to retain the spherical body for movement and a well to allow the steering member to move in different directions, and wherein the mechanical restraining mechanism comprises a ring in relationship to the well, the ring having an opening, the joystick is movable between a first position and a second position, such that when the clamp is located in the first position, the steering member is allowed to move in different directions in the opening, and when the joystick is located in the second position, the steering member is engaged with the ring, rendering the joystick substantially immobile.

11. The electronic device of claim 7, wherein the multi-directional input device comprises a contact plate and a sliding disc movably connected to the contact plate, and the housing comprises a retaining means to retain the contact plate and a well to allow the sliding disc to move in different directions relative to the contact plate, and wherein the mechanical restraining mechanism comprises a clamp disposed relative to the well so as to allow the sliding disc to engage with the clamp, rendering the sliding disc substantially immobile.

12. The electronic device of claim 7, wherein the multi-directional input device comprises a contact plate and a sliding disc movably connected to the contact plate, the multi-dimensional input device movable between a first position and a second position, and the housing comprises a retaining block having an opening to retain the contact plate and a well to allow the sliding disc to move in different directions relative to the contact plate when the multi-directional input device is located in the first position, and wherein the mechanical restraining mechanism comprises a ring disposed in the upper part of the opening of the retaining block such that when the multi-directional input device is located in the second position, the sliding disc is engaged with the ring, rendering the sliding disc substantially immobile.

13. The electronic device of claim 7, comprising a mobile phone.

14. The electronic device of claim 7, comprising a PDA.

15. A restraining mechanism for use in an electronic device, the electronic device comprising:
a housing; and
a multi-directional input device for inputting information in the electronic device, wherein the multi-directional input device comprises a first device member disposed on the housing and a second device member mechanically linked to the first device member, said restraining mechanism comprising:
a body disposed on the housing in relationship with the multi-directional input device; and
an opening on the body, the opening adapted to receive at least a part of the second device member of the multi-directional input device, such that when said part of the second device member is disengaged from the opening, the second device member is movable relative to the body of the restraining mechanism in order to input information in the electronic device, and when said part of the second device member is mechanically engaged in the opening, the body of the restraining mechanism renders the second device member immobile for preventing the input device from inputting information in the electronic device.

16. The restraining mechanism of claim 15, wherein the multi-directional input device comprises a joystick having a spherical body and a steering member connected to the spherical body and wherein the opening is adapted to receive a part of the steering member such that when said part of the steering member is mechanically engaged in the opening, the body of the restraining mechanism renders the steering member immobile.
